(19) United States
(12) Patent Application Publication
(10) Pub. No.: US 2023/0193169 A1
(43) Pub. Date: Jun. 22, 2023

(54) CLEANER FOR ELECTRONIC DEVICE COMPONENTS

(71) Applicant: Henkel AG & Co. KGaA, Duesseldorf (DE)

(72) Inventors: William Gregory Kozak, Waterford, MI (US); Yong Du, Shanghai (CN)

(21) Appl. No.: 18/167,424

(22) Filed: Feb. 10, 2023

Related U.S. Application Data
(63) Continuation of application No. PCT/CN2020/119915, filed on Oct. 9, 2020.

(51) Int. Cl. C11D 11/00; C11D 1/83; C11D 3/04; C11D 3/06; C11D 3/30; C11D 3/36; C11D 3/37; C11D 3/20; C11D 3/43

(52) U.S. Cl. CPC C11D 11/0047; C11D 1/8305; C11D 3/044; C11D 3/06; C11D 3/30; C11D 3/361; C11D 3/3765; C11D 3/2068; C11D 3/43; C11D 1/72

(57) ABSTRACT

A cleaner useful in removing undesirable polymeric material deposits adhered within small bore holes of electronic components is provided, as well as apparatus and methods for carrying out cleaning of such components.

### FIELD OF THE INVENTION

The present invention is directed to an industrial cleaner composition for electronic device components that is particularly useful in manufacturing processes. The components to be cleaned may comprise any material, having bare, ceramicized or anodized metallic surfaces, including electronic device components comprising metal surfaces comprising an oxide layer. More particularly, the present invention is directed to cleaner compositions which can be formulated to have a low level of volatile organic compounds (VOC) and which are effective at removing polymeric material adhered within small bore holes of electronic components, as well as apparatus and methods for carrying out cleaning of such components.

### BACKGROUND

During their manufacture, electronic devices and manufactured metallic components thereof can acquire unwanted materials on their surfaces including but not limited to adhesives and sealants. Electronic devices, e.g. cell phones, contain a variety of sensitive electronic components vulnerable to damage from moisture, which has prompted manufacturers to waterproof (hereinafter also referred to as “seal”) the devices with various means including polymeric sealants, sometimes employing vacuum impregnation processes. The build-up of adherent polymeric material used to seal the electronic device can be deleterious, particularly to small bores intended to house screws in later assembly steps. It is therefore desirable to remove such unwanted polymeric material from the bodies and parts, in particular from small threaded bores made for later assembly of the electronic device. Given that conventional cleaning materials and methods are often inadequate for removing adherent polymeric material from bores and other small crevices without damaging the seal or components, there is a need in the art to provide an alternative composition having an effective cleaning performance of small bores in short cycle times which further: has a low volatile organic compound (VOC) level; is non-corrosive of electronic device surfaces; and, can be readily removed from the cleaned surface such that the cleaner does not interfere with later processing. The present invention addresses this need.

### Problem to be Solved

Waterproofing of cell phones using vacuum impregnation (VI) introduces a polymer dispersion into gaps between individual parts (e.g. components and/or assemblies) that comprise the external cell phone surface, which after drying, with or without curing or crosslinking, seals the phone and prevents water intrusion. During the VI process, polymer dispersion also undesirably penetrates small bores (e.g. screw holes) intended to accept screws in later assembly. The polymeric material remains in the bores, agglomerates into a solid polymeric material deposits adhering to the bore surfaces, which interferes with later insertion of screws during assembly. Another area where polymeric material deposits accumulate has been found where dissimilar metals are in contact.

### Means for Solving the Problem

The invention provides a cleaner and method of cleaning that effectively cleans polymeric deposits from electronic component surfaces and penetrates hard-to-reach locations, e.g. the small bores for screws; breaks up the solid polymeric deposits; facilitates removal of the polymeric material residues from the bores and prevents redeposition on surfaces of the component. The aqueous cleaner comprises at least one chelant for binding inorganic contaminants, such as polyvalent cations, that contribute to polymer agglomeration; at least one non-ionic surfactant, at least one anionic surfactant, and one or more solvents; these components work synergistically to extract the inorganic contaminants from the polymer, breaking apart the solid polymeric deposits, facilitating their removal from the bores. Dispersants in the cleaner then stabilize the removed polymeric material thereby preventing its redeposition on the surface of the cleaned component.

### SUMMARY OF THE INVENTION

An object of the invention is to provide a liquid cleaner concentrate composition and a liquid working cleaner bath, useful to remove multiple different types of polymeric deposits, typically from a vacuum impregnation process, such as gummy solids and hard adherent solids comprising associated cations, as well as polymeric material deposits at dissimilar metal contact points, also referred to herein generically as “polymeric material deposits” or “polymeric deposits”. Another object is to provide a process of removing the polymeric deposits from bores, holes, edges, nooks, and crannies on an article, without damage to other surfaces of the article, desirably in a short process time.

According to one aspect of the invention (“Aspect 1”), a cleaner composition is provided for electronic device components that comprises, consists essentially of, or consists of:
A) water, preferably deionized water;
B) at least one source of alkalinity;
C) at least one detergent builder, different from any of the foregoing components;
D) at least one chelant, different from any of the foregoing components;
E) one or more non-ionic surfactants, different from any of the foregoing components, desirably a combination of at least two of nonionic surfactants:
   E1) a detersive agent;
   E2) an anti-foaming agent; and
   E3) a wetting agent;
F) at least one anionic surfactant, different from any of the foregoing components;
G) at least one dispersant, different from any of the foregoing components, preferably an anionic polymeric dispersant;
H) at least one hydrotrope, different from any of the foregoing components;
I) at least one organic solvent, different from any of the foregoing components, preferably water soluble.

Further illustrative aspects, each of which may be independently combined with one or more other aspects, of the present invention may be summarized as follows:

Aspect 2: The cleaner composition of Aspect 1, wherein D) the at least one chelant, comprises at least two chelants comprising a polycarboxylic acid chelating agent and a phosphonic acid chelating agent; desirably wherein the polycarboxylic acid chelating agent, the phosphonic acid chelating agent are hydroxy substituted.

Aspect 3: The cleaner composition of Aspect 1 or 2, wherein component E) the one or more non-ionic surfactants comprises:
E1) at least one detersive agent, different from any of the foregoing components, selected from alkoxylated mono alcohols, where the alkoxy groups are selected from ethoxy, propoxy, butoxy and combinations thereof;
E2) at least one antifoaming agent, different from any of the foregoing components, selected from ethers, alcohols and glycols, preferably an alcohol that is a diol; and
E3) at least one wetting agent, different from any of the foregoing components, comprising two or more C8-C14 ethoxylated alcohols.

Aspect 4: The cleaner composition of any of Aspects 1 to 3, wherein the one or more non-ionic surfactants comprises at least three non-ionic surfactants, different from any of the foregoing components where:
E1) the detersive agent comprises a plurality of non-ionic surfactants, comprising an ethoxylated secondary alcohol and an aromatic ethoxylated alcohol;
E2) the anti-foaming agent comprises a C8-C18 saturated or unsaturated branched diol;
E3) the wetting agent comprises a plurality of saturated C8-C14 alcohols having 2-20 mols of ethoxylation; desirably one or more ethoxylated alcohols corresponding to the general formula:

R3-(OCH2CH2)nOH (E3)
where R3 is a C6 to C18 alkyl; desirably C8 to C14 alkyl; and
n is in a range of 1 to 30, desirably 2 to 24, preferably 1 to 12.

Aspect 5: The cleaner composition of any of Aspects 1 to 4, wherein F) the at least one anionic surfactant is selected from alkyl sulfates, alkyl sulfonates, alkyl phosphates, alkyl phosphonates, alkylsulfosuccinates, and their ethoxylated analogs.

Aspect 6: The cleaner composition of any of Aspects 1 to 5, wherein G) the at least one dispersant comprises an anionic organic polymeric dispersant with MW in a range of about 5,000 to about 10,000 grams/mol, and comprising one or more polar or dissociable functional groups selected from hydroxyl (—OH), carboxyl (—COOH), sulfonate, sulfate, amino (—NH2), imino (—NH—), and polyoxyethylene (—CH2 CH2O—) groups. Desirably the anionic organic polymeric dispersants is selected from condensed naphthalene sulphonic acid; condensed 1-naphthol 6-sulphonic acids; a fatty alcohol ethylene oxide condensate; an alkyl aryl sulphonate; and lignin sulphonate; sulfonic acids polyacrylic acid (PAA), polymethacrylic acid (PMAA); and salts thereof.

Aspect 7: The cleaner composition of any of Aspects 1 to 6, wherein H) the at least one hydrotrope, comprises one or more of butyl benzene sulfonate, sodium benzoate, sodium benzene sulfonate, sodium benzene di-sulfonate, sodium m-nitrobenzene sulfonate, sodium butyl monoglycol sulfate, sodium cinnamate, sodium cumene sulfonate, sodium p-toluene sulfonate, sodium salicylate, sodium xylene sulfonate and combinations thereof.

Aspect 8: The cleaner composition of any of Aspects 1 to 7, wherein I) the at least one organic solvent comprises a glycol ether, a glycol ether ester or a combination thereof. The generic term glycol ether includes monoglycol ether and polyglycol ether; and the generic term glycol ether ester includes monoglycol ether ester and polyglycol ether ester. Desirably the at least one organic solvent may comprise one or more of ethylene glycol phenyl ether, propylene glycol phenyl ether, dipropylene glycol n-propyl ether; diethylene glycol monobutyl ether acetate; diethylene glycol monohexyl ether; bis-dipropylene glycol n-butyl ether adipate; and combinations thereof.

Aspect 9: A method of cleaning electronic device components, comprising, consisting essentially of or consisting of steps of:
contacting a surface of an article of manufacture, a component, or an assembly thereof, (a part) with the cleaner composition of any one of the foregoing Aspects;
optionally inducing movement of the cleaner composition relative to the surface of the part;
maintaining contact between the cleaner composition and the part surfaces for a time sufficient to remove polymeric material deposits from surfaces of the part, in particular holes and bores in said part;
removing the part from the cleaner composition;
rinsing any residual cleaner composition and any residues of polymeric material deposits from the part surface and
optionally drying the part.

Aspect 10: The method of Aspect 9, wherein the electronic device components have a low mass in a range of about 2 grams to about 50 grams and/or intricate geometries; and the contacting step is at a temperature of less than 90° C., desirably in a range of about 15° C. to about 75° C. and most preferably about 20° C. to about 40° C.

Aspect 11: The method of Aspect 9 or 10, wherein the contacting step is for a time ranging from about 0.5-15 minutes, preferably about 1-10 minutes, most preferably about 2-7 minutes.

Aspect 12: The method of Aspect 9 or 10 or 11, wherein the electronic device components comprise bare, ceramicized or anodized metal surfaces, and the metal surfaces being comprised of at least one of aluminum, titanium, magnesium, or stainless steel.

Desirably the liquid cleaner compositions are environmentally friendly, e.g. free of alkylphenol ethoxylates (APE), which have C8-C9 chains of carbon atoms attached to a phenol ring, e.g. nonylphenol ethoxylates; free formaldehyde; and aromatic solvents, such as unsubstituted aromatic solvents such as benzene, toluene, xylene and the like, and low content of volatile organic compounds. As used herein, the term “volatile organic compound’ (VOC) is defined as a carbon-containing compound—excluding methane, carbon monoxide, carbon dioxide, carbonic acid, metallic carbides or carbonates, ammonium carbonate, and other exempt compounds under 40 Code of Federal Regulations (CFR) § 51.100(s)—that has a vapor pressure of at least 0.01 kPa at standard room temperature (EC Directive 1999/13/EC). Measurement of the VOC emissions of the compositions of the present invention should be conducted in accordance with ASTM Standard Test Method D2369-90.

For ease of use and safety, the cleaner concentrate composition desirably has a high flash point, preferably greater than in increasing order of preference 90, 91, 92, 94, 96, 98, 99° C.

The term “solvent” means a liquid, other than water, that serves as the medium to at least partially dissolve a solute, e.g. a component of a cleaner composition or cleaner concentrate according to the disclosure, for example non-ionic surfactants, and/or at least partially dissolve or dispersed contaminants, e.g. agglomerated polymeric material. Solvent as used herein may include organic molecules, inorganic molecules, and mixtures thereof, unless otherwise defined in the description.

The term “soluble” with respect to any component means that the component acts as a “solute” which dissolves in water, a solvent or solvent system or composition thereby forming a solution, which does not form separate phases, whether liquid or solid, e.g. a precipitate.

For a variety of reasons, it is preferred that compositions and concentrates disclosed herein may be substantially free from many ingredients that may be used in compositions for similar purposes in the prior art. Specifically, it is increasingly preferred in the order given, independently for each preferably minimized ingredient listed below, that at least some embodiments of coating compositions or concentrates according to the invention contain no more than 1.0, 0.5, 0.35, 0.10, 0.08, 0.04, 0.02, 0.01, 0.001, or 0.0002 percent, more preferably said numerical values in grams per liter, more preferably in ppm, of each of the following constituents: organic materials containing any silicon or fluorine atoms, by way of non-limiting example, fluorinated surfactants, organosilanes and similar molecules; cationic surfactants; aromatic solvents, such as benzene, toluene, xylene and the like; as well as other volatile organic compounds such as d-limonene, acetone, ethanol, 2-propanol, hexanol; imidazole; insoluble solids such as fillers, polishing agents and the like, for example calcium carbonate, silica, oxidizing agents such as peroxides and peroxyacids, permanganate, perchlorate, chlorate, chlorite, hypochlorite, perborate, hexavalent chromium, sulfuric acid, nitric acid and nitrate ions; as well as, formaldehyde, formamide, cyanides, cyanates; rare earth metals; boron, e.g. borax, borate; strontium; and/or free halogen ions, e.g., fluoride, chloride, bromide or iodide. Also, it is increasingly preferred in the order given, independently for each preferably minimized ingredient listed above, that at least some embodiments of surfaces cleaned according to the invention, contain no more than 1.0, 0.5, 0.35, 0.10, 0.08, 0.04, 0.02, 0.01, 0.001, or 0.0002 percent, more preferably said numerical values in parts per thousand (ppt), of each of the aforestated constituents. In certain embodiments, the compositions of the invention are free of one or more of the above listed minimized ingredients.

The simple term “metal” or “metallic’ will be understood by those of skill in the art to mean a material, whether it be an article or a surface, that is made up of atoms of metal elements, e.g. aluminum or iron, the metal elements present in amounts of at least, with increasing preference in the order given, 55, 65, 75, 85, or 95 atomic percent. A bare metallic surface will be understood to mean a metallic surface in the absence of a coating layer, other than naturally occurring oxides derived from the metallic surface through aging in air and/or water. Anodized metal substrates will be understood to mean a metal substrate having a layer of metal oxide generated on bare metal surfaces of the metal substrate by passing electricity through the metal article as the anode in a circuit in the presence of electrolyte, the oxide coating may include metals from the electrolyte in addition to those from the metal substrate. Ceramicized metal substrate means a metal surface having a coating comprising oxide, carbide, boride, nitride, or silicide, which may be deposited by various means known in the art such as plasma spray, HVOF, chemical vapor deposition, and the like.

Other than in the operating examples, or where otherwise indicated, all numbers expressing quantities of ingredients, reaction conditions, or defining ingredient parameters used herein are to be understood as modified in all instances by the term “about”. Throughout the description, unless expressly stated to the contrary: percent, “parts of”, and ratio values are by weight or mass; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description or of generation in situ within the composition by chemical reaction(s) between one or more newly added constituents and one or more constituents already present in the composition when the other constituents are added; specification of constituents in ionic form additionally implies the presence of sufficient counterions to produce electrical neutrality for the composition as a whole and for any substance added to the composition; any counterions thus implicitly specified preferably are selected from among other constituents explicitly specified in ionic form, to the extent possible; otherwise, such counterions may be freely selected, except for avoiding counterions that act adversely to an object of the invention; molecular weight (MW) is weight average molecular weight unless otherwise specified; the word “mole” means “gram mole”, and the word itself and all of its grammatical variations may be used for any chemical species defined by all of the types and numbers of atoms present in it, irrespective of whether the species is ionic, neutral, unstable, hypothetical or in fact a stable neutral substance with well-defined molecules.

This section provides a general summary of the disclosure and is not a comprehensive disclosure of its full scope or all features, aspects, or objectives. These and other features and advantages of this disclosure will become more apparent to those skilled in the art from the detailed description of a preferred embodiment. The drawings that accompany the detailed description are described below.

### DETAILED DESCRIPTION OF PREFERRED EMBODIMENTS

In a first embodiment of the invention, a cleaner is provided that is useful in removing adherent polymeric deposits from hard-to-reach locations on metal components of electronic devices. In a particular embodiment, the cleaner penetrates small diameter (e.g. 0.5-2 mm or average 1-mm diameter, dead-end screw holes on anodized aluminum cell phone assemblies) and removes polymeric deposits/agglomerated latex particles adhered to the surfaces in the bores of the screw holes.

The cleaner works in mild cleaning conditions, as will be described herein, by way of non-limiting example operating conditions may be i.e. ambient temperature 20 to 38° C., short immersion times, low cleaner concentrations, and has no ultrasonic or electrolytic energy requirements. Another benefit of the cleaner and processes of using it are the mild cleaning conditions do not negatively impact other portions of the metal part assembly, e.g. anodized or ceramicized metal, in particular aluminum, surfaces are not affected by the cleaning process. The mild processing conditions also permit cleaning of polymeric deposits from cell phones waterproofed via vacuum impregnation (VI) without damage to the VI produced polymer seal of the phone.

This cleaner is useful in a process to waterproof cell phones using vacuum impregnation (VI) with polymer composition. In one embodiment, a viscous, high-solids latex polymer composition is pressured into gaps between individual parts that comprise the external cell phone surface. Latex as used herein means a dispersion of microscopic polymer particles in water; desirably, the particles do not separate or coagulate due to ionic or steric stability. Ionic stability is the result of ionic charges on particles, producing a repulsive force that prevents agglomeration. Steric stability arises when the surfaces of polymer particles extend into the solution, keeping the particles apart physically. After drying, this polymer becomes a flexible seal that prevents water intrusion. However, during the VI process, some polymer solution also penetrates hard-to-reach locations that must not be sealed prior to further assembly (e.g. screw holes). Once the latex polymer composition is pressured into holes, bores, and other hard-to-reach locations, it tends to adhere to the sides forming a clog that conventional cleaners are ineffective in removing.

Another problem arises in some articles which have been pretreated in earlier processing. Due to mass transfer limitations, in some VI impregnated articles, these same hard-to-reach locations are often not completely cleaned of chemistry from earlier processing (e.g. aluminum anodization and/or seals) and consequently these hard-to-reach locations may have some residual contamination of polyvalent cations—e.g. Al⁺³ from the anodization and/or Ni⁺² from the anodization seal. When the inert polymer latex is pressured into these hard-to-reach locations, residual polyvalent cations bridge between anionic functionalities on adjacent latex particles which reduces the electrostatic repulsion between the latex particles. With insufficient electrostatic repulsion, latex particles can agglomerate into a solid polymeric deposit. These polymeric deposits are almost impossible to remove using normal cleaners and/or cleaning processes due to chemical stability of the deposits (i.e. equilibrium) and/or mass transfer limitations in getting cleaner chemicals into the hard-to-reach locations (i.e. kinetics). Polymeric deposits in these hard-to-reach locations prevent further cell phone assembly—e.g. since screws cannot be easily threaded into plugged screw holes.

Cleaners according to the invention effectively penetrate these hard-to-reach locations and without being bound by a single theory, it is thought that chelants in the formulation bind with the polyvalent ions more strongly than the anionic functionalities on the polymeric deposits thereby extracting the polyvalent cations from the deposits into a chelant-ion complex in the liquid cleaner phase, which breaks apart the solid deposits and permits removal of the polymeric material from the hard-to-reach locations. Dispersants in the cleaner tend to stabilize the removed polymeric material residues such that it does not redeposit on the cleaned article. These advantages are particularly important in mass production of cell phones since individual cell phones cannot be inspected due to the rate at which they are manufactured. Furthermore, the cleaner is so effective that extreme process conditions (e.g. high temperature, long immersion time, ultrasonic energy, etc.) are not needed in the cleaner tanks. The absence of such extreme process conditions minimizes polymer removal from locations that need to be sealed to maintain water tightness.

This cleaner is a particularly effective combination of multiple functional components which can include alkalinity sources, detergent builders, chelants, dispersants, non-ionic surfactants including detersive agents, wetting agents, and anti-foaming agents, hydrotropes, solvents and the like. The liquid cleaner composition, which may be a cleaner concentrate composition or a working cleaner bath composition, as described more fully below and defined in the appended claims. The liquid cleaner composition comprises, or may consist essentially of or may consist of:
A) water;
B) at least one source of alkalinity;
C) at least one detergent builder, different from any of the foregoing components;
D) at least one chelant, different from any of the foregoing components;
E) one or more non-ionic surfactants, different from any of the foregoing components, desirably a combination of at least two of:
   E1) a detersive agent;
   E2) an anti-foaming agent; and
   E3) a wetting agent;
F) at least one anionic surfactant, different from any of the foregoing components;
G) at least one dispersant, different from any of the foregoing components, e.g. an anionic polymeric dispersant;
H) at least one hydrotrope, different from any of the foregoing components;
I) at least one organic solvent, different from any of the foregoing components.

The composition may further comprise additives including, but not limited to oxidant, emulsifier, acidic pH adjuster, corrosion inhibitor, biocide, preservatives, and the like.

In the cleaner composition, components containing Si or F that would tend to interfere with downstream processing and/or adhesion of subsequent treatments are minimized; in a preferred embodiment the cleaner composition is free of organic materials containing any silicon or fluorine atoms, by way of non-limiting example, fluorinated surfactants, organosilanes and similar molecules.

Component A) of water can be tap water, provided mineral content or other contaminants do not interfere with objects of the invention, and desirably may be filtered, deionized, or distilled water. Component A) is desirably minimized in the cleaner concentrate composition, with sufficient water being present to dissolve water soluble components and maintain a stable dispersion. Desirably water in the cleaner concentrate composition may be present in a range of about 50-75 wt. %, optionally water may be present in an amount of at least in increasing order of preference 30, 35, 40, 50, 55, 60, 65, or 70 wt. %, based on the weight of the cleaner concentrate composition. In some embodiments the cleaner concentrate may comprise about 75-80 wt. % or higher. Amounts of water greater than 80 wt. % may be included in the cleaner concentrate composition provided that adequate cleaning performance and stability are achieved in the cleaner working bath at 1% to 10 wt. % concentrate. In one embodiment, water is present in an amount of, in increasing order of preference, at least 50, 51, 52, 53, or 54 wt. % and in increasing order of preference, up to 68, 66, 64, 62, 60, or 58 wt. %, based on the weight of the cleaner concentrate composition. In cleaner working baths, water may be present in amounts of no more than about 99, 97, 95, or 90 wt. %.

Component B) at least one source of alkalinity can be an inorganic or organic alkaline ingredient soluble in the cleaner concentrate that does not interfere with the objects of the invention. Suitable materials that may be a source of alkalinity include NaOH, KOH, NH₄OH, alkanolamines, such as monoethanolamine, diethanolamine and triethanolamine; and similar alkaline ingredients. In one embodiment, the source of alkalinity comprises an inorganic compound and an organic compound. Desirably Component B) is present in an amount sufficient to achieve a cleaner concentrate pH in a range of about 4 to about 10, desirably the concentrate may have a pH range of about 6 to about 9. The total amount of alkaline ingredient to be included in the cleaner concentrate varies with the types and amounts of acidic components used in the cleaner concentrate; desirably the amount of Component B) ranges from about 1 wt. % to less than 10 wt. %; preferably about 1 wt. % to about 5%. In one embodiment, the at least one source of alkalinity is present in an amount sufficient to adjust the pH of the cleaner concentrate to within a range of about 8.0-8.5. In some embodiments, an acidic pH adjuster may be used in addition to Component B); alternatively, the acidic pH adjuster may be absent.

Component C) at least one water-soluble detergent builder having one or more of functions to, for example, reduce the deleterious activity of hardness ions (e.g. Ca⁺⁺ and Mg⁺⁺), assist in the removal of nonpolar components of polymeric material deposits (optionally emulsification thereof), deflocculate particulate polymeric material residues, buffer in desirable pH ranges, and decrease polymeric material residue redeposition by stabilization of the dispersed polymeric material in the cleaner. Selection of the builders may be made based upon their solubility in water and in a concentrate, as well as the polymeric material deposits to be removed. Suitable detergent builders are water soluble and may include inorganic phosphates, inorganic silicates, inorganic carbonates, zeolites, and the like. Water-soluble silicates and phosphates having Na, K, Li, and quaternary ammonium counterions are preferred. Non-limiting examples of inorganic silicates include sodium silicate and potassium silicate and the like. Non-limiting examples of inorganic phosphates include mono-phosphates, metaphosphates, polyphosphates and pyrophosphates, such as trisodium phosphate (TSP), sodium metaphosphate (SMP), sodium tripolyphosphate (STPP), tetrasodium pyrophosphate (TSPP), tetrapotassium pyrophosphate (TKPP), and the like. Component C) is present in an amount of at least in increasing order of preference 0.1 to 5.0 wt. %, desirably about 0.2 to 4.5 wt. %, and preferably about 0.5 to 3 wt. %, based on the weight of the cleaner concentrate composition. In one embodiment, Component C) is present in an amount of, in increasing order of preference, at least 0.1, 0.2, 0.3, 0.4, 0.5, 0.6 or 0.7 wt. % and in increasing order of preference, not more than, at least for economy 7.0, 6.0, 5.0, 4.7, 4.0, 3.5 or 2.5 wt. %.

Component D) at least one chelant, different from any of the foregoing components, is a water soluble compound comprising polar functional groups capable of chelating metals and/or metal ions. Component D) chelants may be of various types, and include organic materials such as carboxylic acids or inorganic materials such as polyphosphates. The chelants tend to form water-soluble multidentate complexes with the metal ions in particular polyvalent metals, by way of non-limiting example aluminum, magnesium or nickel, thereby facilitating removal of the metal ions from the solid polymeric material in bores, holes and other areas where cleaner to surface contact is restricted. Approximately twenty-five different chelants were tested for capability to affect solid polymeric material. Test results showed chelants useful in the invention, as further described below, induced desorption of metal ions which are associated with polymeric material adhering to surfaces of the articles to be cleaned. While metal ions are being chelated, other components of the cleaner compositions work synergistically with the chelant to remove solid polymeric material. In one embodiment, a plurality of different chelants comprised Component D), preferably at least two chelants.

Suitable chelants may include amine backbone molecules having acid functionality, such as amino alkanoic acids and salts thereof, e.g. alkylenepolytertiaryaminepolycarboxylic acids and salts thereof; more particularly ethylenediaminetetraacetic acid, ethylenediaminetetraacetic acid tetrasodium salt, diethylenetriaminepentaacetic acid, diethylenetriaminepentaacetic acid pentasodium salt, N-hydroxyethylethylenediaminetetraacetic acid, N-hydroxyethylethylenediaminetetraacetic acid trisodium salt. Other alkylenepolyaminealkanoic acids include ethylenediaminediacetic acid, ethylenediaminetriacetic acid, diethylenetriaminediacetic acid, diethylenetriaminetriacetic acid, diethylenetriaminetetraacetic acid, triethylenetetraaminediacetic acid, triethylenetetraaminetriacetic acid, triethylenetetraaminetetraacetic acid, triethylenetetraaminepentaacetic acid, triethylenetetraaminehexaacetic acid, tetraethylenepentaaminediacetic acid, tetraethylenepentaaminetriacetic acid, tetraethylenepentaaminetetraacetic acid, tetraethylenepentaaminepentaacetic acid, tetraethylenepentaaminehexaacetic acid, tetraethylenepentaamineheptaacetic acid, N-hydroxyalkylalkylenepolyamines including N-hydroxymethylethylenediaminediacetic acid, N-hydroxymethylethylenediaminetriacetic acid, N-hydroxyethylethylenediaminediacetic acid, N-hydroxypropylethylenediaminediacetic acid, N-hydroxy propylethylenediaminetriacetic acid, N-hydroxypropylpropylenediaminediacetic acid, N-hydroxypropylpropylenediaminetriacetic acid, N-hydroxybutylethylenediaminediacetic acid, N-hydroxybutylethylenediaminetriacetic acid, N-hydroxypropylpropylenediaminediacetic acid, N-hydroxypropylpropylenediaminetriacetic acid; as well as the corresponding propionic acid derivatives, butyric acid derivatives, and the sodium salts of the above recited compounds.

Other non-limiting examples of chelants which may be used in the invention, provided that they do not unduly interfere with performance thereof, include phosphorus-containing chelants including phosphonic acids, such as EDTA-like phosphonic acids and salts thereof where phosphonic acid functional groups substitute for carboxylic acid functional groups, e.g. ethylenediamine tetra(methylenephosphonic acid), and unsubstituted or substituted bisphosphonic acids and salts thereof, e.g. methylene diphosphonic acid; 1-hydroxyethylidine bisphosphonic acid; 3-amino-1-hydroxypropylidene-diphosphonic acid; 4-amino-1-hydroxybutylidene-1,1-bisphosphonic acid; 6-amino-1-hydroxyhexylidene)diphosphonic acid and the like; as well as phosphorylated alcohols such as phytic acid and salts thereof. Other suitable chelants may include alkyl carboxylic acids and salts thereof; such as hydroxy substituted carboxylic acids and salts thereof; polycarboxylic acids and salts thereof, which may have hydroxy substitution. In one embodiment, the alkyl carboxylic acids comprise C4-C8, preferably C4-C6 acids, at least one of the carbons having carboxylic acid functionality (—COOH), preferably more than one; and further comprising at least one hydroxy (—OH) functional group. Non-limiting examples thereof include citric acid, gluconic acid, malic acid, tartaric acid. In one embodiment, ascorbic acid ((2R)-2-[(1S)-1,2-dihydroxyethyl]-3,4-dihydroxy-2H-furan-5-one) acts as the chelant.

Component D) may be present in an amount in a range of about 0.2-25 wt. %, desirably about 0.5-10 wt. %, or preferably about 1.0-4.0 wt. %, based on the weight of the cleaner concentrate composition. In one embodiment, Component D) is present in an amount of, in increasing order of preference, at least 0.5, 0.75, 0.8, 1.0, 1.4, 1.8, or 2.0 wt. % and in increasing order of preference, not more than 25.0, 23.0, 21.0, 19.0, 17.0, 16.0, 12.0, 10.0, 8.0, 6.0, or 4.0 wt. %.

Component E) of one or more non-ionic surfactants, different from any of the foregoing components, is desirably comprised of at least one of, preferably at least two of:
E1) a detersive agent comprised of amphiphilic non-ionic surfactants, meaning they have both hydrophobic and hydrophilic uncharged regions. Possible nonionic surfactants can be glycosides (sugar alcohols); sorbitol fatty esters; polyoxyethylenes, such as polyether alcohols, castor oil ethoxylates, tallow amine ethoxylates; esters, such as phosphate esters, polyethylene glycol esters, and the like. Generally, polyether alcohols may comprise an alkoxylated C6-C14 aromatic or alkane, primary or secondary alcohol. Desirably, E1) may be comprised of non-ionic detersive agents that include alkoxylated alcohols, which comprise alkoxy groups selected from ethoxy, propoxy, butoxy and combinations thereof. The alkoxylation may be PO-EO block, random alkoxylation, alkoxy group block with a hydrophilic EO end cap and the like; preferably ethoxylated alcohols. Primary alcohol ethoxylates, secondary alcohol ethoxylates and benzyl alcohol ethoxylates are preferred. In a preferred embodiment, the detersive agent comprises a plurality of non-ionic surfactants, one of said plurality being an aromatic ethoxylated non-APE alcohol.
E2) an anti-foaming agent comprising non-ionic surfactants different from any of the other components herein. Antifoaming agents are added to prevent or counter the foam generation in the cleaner formulation. Generally, these agents are sparingly to partially soluble in the cleaner, easily spread on the foamy surface, and possess affinity to the air-liquid surface where the agents destabilize the foam lamellas, which rupture the air bubbles and break down the surface foam. Entrained air bubbles are agglomerated, and the larger bubbles rise to the surface of the bulk liquid more quickly. Commonly used antifoaming agents, non-ionic surfactant or other, that may be included in cleaners, provided that they do not unduly interfere with performance, leave residue on the part surfaces or negatively affect later processing comprise stearates, hydrophobic insoluble particles, ethers, alcohols and glycols. Desirably, E2) is free of silicon-containing and fluorine-containing anti-foaming agents. In one embodiment, the anti-foaming agent may comprise a C8-C18 saturated or unsaturated branched diol. Preferred anti-foaming agents comprise amphiphilic non-ionic surfactants, for example saturated polyalcohols, e.g. propane 1,2,3-triol; unsaturated polyalcohols, e.g. so-called Gemini surfactants, acetylenic diols, such as 2, 5, 8, 11-Tetramethyl-6-dodecyne-5, 8-diol; saturated linear polyalcohols and unsaturated linear polyalcohols, such as diols, triols and the like.
E3) a wetting agent comprised of one or more non-ionic surfactants selected from molecules having one or more moles of ethoxylation, different from any of the other components herein. Suitable wetting agents include polyether alcohols typically ethoxylated alkyl alcohols having at least 1 mol of ethoxylation, e.g. C8-C18 alcohols having 2-25 mols of ethoxylation. The wetting agent may comprise diethylene glycol monoesters of fatty acids possessing 8, 9, and 10 carbon atoms and triethylene glycol monoesters of fatty acids containing 9 and 10 carbon atoms. Component E3 may comprise a mixture of suitable wetting agents. Desirably component E3 comprises a mixture of C8-C14 alcohols having 2-20 mols of ethoxylation.
In one embodiment the wetting agent comprises on or more ethoxylated alcohols corresponding to the general formula E3:

R³—(OCH₂CH₂)ₙOH (E3)
where R³ is a C6 to C18 alkyl; desirably C8 to C14 alkyl; and
n is in a range of 1 to 30, desirably 1 to 12.
   Desirably, the wetting agent has a static surface tension of less than about 34, 33, 32, 31, or 30 and no more than about 22, 23, 24, 25, 26, or 27 and a Draves wetting time of no more than 75, 72, 70, 60, 50, 40, 30, 20, or 10 secs. Preferably the Draves wetting time is minimized to be in a range of 1-30 second, most preferably 3-10 seconds.

Component E) of the one or more non-ionic surfactants is present in a total amount in a range of about 1.0 to 30.0 wt. %, desirably about 2.0-25.0 wt. %, preferably about 2.5-21.0 wt. % and more preferably 5.0 to 15.0 wt. %, based on the weight of the cleaner concentrate composition. In one embodiment, Component E) is present in an amount of, in increasing order of preference, at least 1.0, 2.0, 3.0, 4.0, 5.0, 6.0 or 7.0 wt. % and in increasing order of preference, not more than 28.0, 26.0, 25.0, 23.0, 20.0, 19.0, 17.0, 16.0, 13.0, 11.0 or 10.0 wt. %. The foregoing amounts for Component E) are the sum of amounts of non-ionic surfactants present whether as a detersive agent, an antifoaming agent, a wetting agent, or a combination of 2 or more of E1), E2) and E3). In one embodiment, at least 0.01 to 5.0 wt. %, preferably 0.1 to 2.0 wt. % of Component E) present in the concentrate composition is the anti-foaming agent E2). Also, although the nonionic surfactants of Component E, are described for clarity as if they each have a single individual function, it will be understood by those of skill in the art that a single nonionic surfactant chemistry may perform several functions, e.g. detergency, dispersion, wetting, etc., simultaneously but with greater or lesser performance. In some embodiments, a nonionic surfactant compound may provide a combination of more than one of anti-foaming, wetting and detersive effects.

Component F) of at least one anionic surfactant, different from any of the foregoing components, is a water soluble compound comprising functional groups capable of dispersing the polymeric material and/or metal ions removed from part surfaces such that these polymeric material residues do not redeposit on cleaned part surfaces. Component F) anionic surfactants may be of various types, such as alkyl sulfates, alkyl sulfonates, alkyl phosphates, alkyl phosphonates, alkylsulfosuccinates, etc. and their ethoxylated analogs and include sodium lauryl sulfate, sodium laureth sulfate, and sodium bis(2-ethylhexyl)sulfosuccinate. Component F) may be present in an amount of at least in increasing order of preference 1.0 to 10.0 wt. %, desirably about 2.0 to 8.0 wt. %, based on the weight of the cleaner concentrate composition. In one embodiment, Component F) is present in an amount of, in increasing order of preference, at least 1.0, 2.0, 3.0, 4.0, or 5.0 wt. % and in increasing order of preference, not more than 13.0, 12.0, 11.0, 10.0, 9.0, 8.0, 7.0, or 6.0 wt. %.

Component G) at least one dispersant, different from any of the foregoing components, may be an anionic organic polymeric dispersant having one or more polar or dissociable functional groups such as hydroxyl (—OH), carboxyl (—COOH), sulfonate, sulfate, amino (—NH₂), imino (—NH—), and polyoxyethylene (—CH₂CH2O—) groups. The polymeric dispersant may have a MW in a range of about 5,000 to about 10,000 grams/mol. Contaminant particles, e.g. polymeric material removed by the cleaner, present in the aqueous working cleaner bath may tend to agglomerate when van der Waals attraction is greater than electrostatic repulsion. Suitable dispersants cause steric hindrance and electrostatic stabilization between the polymeric material residue particles, which prevents them particles from agglomerating. Suitable anionic polymeric dispersants include formaldehyde condensates of either of naphthalene sulphonic acid, cresol, 1-naphthol 6-sulphonic acids, fatty alcohol ethylene oxide condensate, alkyl aryl sulphonates or lignin sulphonates; condensed naphthalene sulfonic acids and salts thereof are preferred. Further examples of anionic polymeric dispersants include polyacrylic acid (PAA), polymethacrylic acid (PMAA) and other suitable polyacrylates and polymethacrylates. Component G) is present in an amount of at least in increasing order of preference 1.0 to 10.0 wt. %, desirably about 2.0 to 8.0 wt. %, based on the weight of the cleaner concentrate composition. In one embodiment, Component G) is present in an amount of, in increasing order of preference, at least 1.0, 2.0, 3.0, 4.0, 5.0, 5.5 or 6.0 wt. % and in increasing order of preference, not more than 15.0, 14.0, 13.0, 12.0, 11.0, 10.0, 9.0, 8.0, 7.0 wt. %.

Component H) at least one organic hydrotrope, different from any of the foregoing components, one of its functions being to increase the ability of water to dissolve poorly soluble organic molecules thereby enhancing stability of the cleaner concentrate and cleaner bath. Hydrotrope, as used herein, refers to water-soluble anionic compounds comprising small, typically C6-C10, desirably C6-C9 molecules. These non-polymeric molecules having hydrophobic and hydrophilic portions that enhance the solubilities of organic materials in the aqueous phase. Hydrotropes as used herein are distinguished from Component F) the anionic surfactant by differences in size. While surfactants possess long hydrocarbon chains, hydrotropes are characterized by a short, compact moiety (often, though not necessarily an aromatic ring) which is hydrophobic in nature. Weight average molecular weight of hydrotropes is in a range of about 100 g/mol and not more than about 250 g/mol, which is smaller than both Component F) and Component G) molecules.

In some embodiments, hydrotropes are capable of increasing the solubility of organic solvents more the 20 times in water, which can aid to stabilize solutions, modify viscosity and increase the cloud-point, limit low-temperature phase separation and/or reduce foam. Suitable hydrotropes may be composed of alkyl, aromatic or alkoxy hydrophobic portions, preferably aromatic, substituted by one or more hydrophilic groups such as sulfate, sulfonate, nitro, or carboxylate groups; aromatic sulfonates are preferred. Non-limiting examples of hydrotropes include butyl benzene sulfonate, sodium benzoate, sodium benzene sulfonate, sodium benzene di-sulfonate, sodium m-nitrobenzene sulfonate, sodium butyl monoglycol sulfate, sodium cinnamate, sodium cumene sulfonate, sodium p-toluene sulfonate, sodium salicylate, sodium xylene sulfonate and combinations thereof. Component H) is present in an amount sufficient to stabilize the cleaner concentrate composition. Generally, the hydrotrope may be present in an amount of at least in increasing order of preference 2-20 wt. %, desirably about 4 to about 18 wt. %, and preferably about 5.0 to 15 wt. %, based on the weight of the cleaner concentrate composition. In one embodiment, Component H) is present in an amount of, in increasing order of preference, at least 1, 2, 3, 4, 5, 7, 9, 11, or 13 wt. % and in increasing order of preference, not more than, at least for economy, 19, 18, 17, 16, 15, or 14 wt. %.

Component I) at least one organic solvent, different from any of the foregoing components may be selected from a glycol ether, glycol ether ester, such as mono glycol or polyglycol ether, mono glycol or polyglycol ether ester and combinations thereof. Suitable organic solvents may include ethylene glycol phenyl ether, propylene glycol phenyl ether, dipropylene glycol n-propyl ether; diethylene glycol monobutyl ether acetate; diethylene glycol monohexyl ether; bis-dipropylene glycol n-butyl ether adipate, a non-HAP, glycol ether ester with <0.5% typical VOC content by ASTM D6886; dibasic ester derivatives of short branched alkyl chain dicarboxylic acids, such as (dimethyl 2-methylglutarate); and the like. Component I) may be present in an amount of at least in increasing order of preference 1.0 to 20.0 wt. %, desirably about 2.0 to 10.0 wt. %, or 2.5 to 9.5 wt. %, based on the weight of the cleaner concentrate composition. In one embodiment, Component I) is present in an amount of, in increasing order of preference, at least 1, 2, 3, 4, 5, 6, 7, 8 or 9 wt. % and in increasing order of preference, up to 20.0, 19.0, 17.0, 16.0, 15.0, 14.0, 13.0, 12.0, 11.0 or 10.0 wt. %.

The composition may further comprise additives including, but not limited to emulsifier, pH adjuster, corrosion inhibitor, biocide, preservatives and the like. The pH adjuster may be any organic or inorganic acid, free of Si, Cl and F, which does not interfere with objects of the invention. Preferably no thickener or abrasives are included in the compositions.

Concentrations recited above describe amounts of components in the cleaner concentrate composition. The concentrate may be used without dilution, but at least for economy's sake, working concentrations of the cleaner are desirably achieved by diluting the concentrate. Preferably, the working bath of cleaner composition may be a 10.0 wt. % dilution of the concentrate or lower down to 1.0 w. % dilution of the cleaner, provided that the cleaning performance is sufficient. Any dilution of the concentrate which does not interfere with objects of the invention for example rinse incompletely or precipitate during use may be used, but generally are unnecessary and uneconomical.

The cleaner concentrate composition of the present invention may be prepared by admixing the components thereof into Component A) of water. Desirably components with low solubility in water may be added with or after the hydrotrope. If necessary, solvent is added last and the composition mixed until a homogenous solution or dispersion is achieved. Additional Component B) the at least one source of alkalinity may be added, with or without an acidic pH adjuster to correct pH.

A method of cleaning an article of manufacture or component or assembly thereof (hereinafter the part), in particular electronic device components, having surfaces bearing adherent polymeric material to be removed (hereinafter contaminants or polymeric material deposits) is also provided. Desirably a liquid working cleaner bath at concentrations in a range of about 1 wt. % to about 10 wt. % of the liquid cleaner concentrate compositions disclosed herein is used in the process. The surfaces to be cleaned may comprise any material, but typically include at least one of metal, anodized metal, ceramicized metal or similar metal coated surfaces. Generally, the metal may be selected from aluminum, titanium, magnesium, stainless steel, and other metals desirable for use in outer portions of handheld electronics, such as cell phones. The part may have holes or bores, optionally threaded, or other orifices having polymeric material deposits therein, which are particularly difficult to remove. Further, due to consumer's desire for lightweight handheld electronics, the substrates to be cleaned may have low mass (about 2-50 grams) and/or intricate geometries that require a cleaner and process desirably avoiding harsh conditions and/or prolonged submersion. A process according to the invention utilizes cleaner compositions as described herein, the process comprising steps of:
1) contacting a surface of an article of manufacture, a component or an assembly thereof (a part) with a cleaner composition as described herein;
2) optionally inducing movement of the cleaner composition relative to the surface; desirably this may be accomplished by bubbling air through the cleaner or oscillating the rack upon which parts are affixed;
3) maintaining contact between the cleaner composition and the part surfaces for a time sufficient to remove polymeric material deposits from surfaces of the part, in particular holes and bores in said part;
4) removing the part from the cleaner composition;
5) rinsing any residual cleaner composition and polymeric material residue from the part surface and
6) optionally drying the part.

Typical cleaner lines include 3 to 10 tanks, the first several of which contain various dilutions of the cleaner concentrate that form working cleaner baths, and the final several of which contain water whose function is to rinse residual cleaner and polymeric material residue from the parts. The temperature, immersion time, and type of agitation can vary from tank to tank, in general with more severe conditions (e.g. higher temperature, type of agitations) toward the beginning of the line and less severe conditions toward the end of the line. Typically, the assemblies to be cleaned are removably attached to racks for transport in the processing line. Desirably the racks with their removably attached assemblies are immersed in tanks containing at least one of the above-described working cleaner baths. Various means are provided for inducing movement of the cleaner bath relative to part surfaces. Typical means may include bubbling apparatus which pass air or inert gas through the working cleaner; ultrasonic energy which may be applied during the cleaning process, provided that it does not negatively impact the part being cleaned; also useful are racks that are moveable within a tank during the contacting step, e.g. rotating, oscillating, pendulum-type, undulating and the like, which may include movement in any of the x, y or z direction, relative to the longitudinal axis of the rack. Though economically not preferred, the tank containing the cleaner bath and racked parts may move or vibrate. During residence time in the cleaner, apparatus to induce movement of the cleaner bath relative to part surfaces can be engaged for at least part of the contacting time.

The process desirably may be run at ambient temperature (about 20 to 40° C.), for economy and ecological purposes, but may be run at lower temperatures down to about 5° C., or higher temperatures up to about 90° C., provided that the temperature does not interfere with objects of the invention, such as negatively impacting waterproofing or other substrates in the assembly being cleaned, inducing separation of the cleaner phase separation or undue solids precipitation. For example, cleaning temperatures may range from at least, in increasing order of preference, of about 4.5, 7, 10, 13, 15, 18, 21, 24, 27, 30, 32, 35 or 38° C., to as great as, in increasing order of preference, about 90, 80, 70, 65, 60, 55, 50, 45 or 42° C. Temperature refers to an average working cleaner bath temperature during a contacting step of cleaning. In one embodiment, temperature may range from about 15° C., to about 75° C. Due to the short processing times in electronics manufacturing, the contacting time between the part and working cleaner bath desirably is in a range of about 1-10 minutes, preferably 2 to 4 minutes. Faster cleaning times may be used provided that it meets manufacturing line requirements.

In one embodiment, the contacting step comprises immersing the part in the cleaner composition. In some embodiments, the cleaning process may be in the absence of application of ultrasonic and/or electrolytic energy. In another embodiment, ultrasonic energy may be applied during the cleaning process, provided that it does not negatively impact polymer seals intentionally introduced into gaps between individual pieces that comprise the part, which after drying seals assemblies.

Inducing movement of the cleaner composition relative to the surface may comprise moving the part in the cleaner composition and/or agitating the cleaner composition, such as bubbling air into the cleaning tanks containing the cleaner composition and the parts to be cleaned, ultrasound and the like.

In particular embodiments, the “polymeric material deposits” to be cleaned may be solid or semi-solid organic polymeric material and may include solid polymeric material comprising organic polymers and transition metal elements.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of a composition, article or process. Additionally, in some embodiments, the invention can be construed as excluding any element or process step not specified as present herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Example 1

For each example, cleaner concentrate compositions for testing were prepared by admixing the components as listed in Table 1. Unless stated otherwise, raw materials in the Examples are undiluted. For those raw materials shown in the tables as being present as a certain weight percent (e.g. NaOH 50 wt. %), the raw material will be understood to be a dilution in water.

The pH of the cleaner concentrates is shown in Table 1. The cleaner concentrates showed no phase separation or precipitate.

TABLE 1

| | Concentrate Cleaner | | | | | | |
|---|---|---|---|---|---|---|---|
| Raw material | Comp. | Comp. | | | | | |
| (Wt. %) | Ex. 1 | Ex. 2 | Ex. 10 | Ex. 11 | Ex. 11.1 | Ex. 12 | Ex. 12.1 |
| Deionized H₂O | 68.78 | 66.38 | 69.796 | 35.747 | 35.179 | 33.559 | 35.091 |
| NaOH (50 wt. %) | | | 9.356 | 2.383 | 2.344 | 2.270 | 2.343 |
| Triethanolamine | | | | 3.261 | 3.256 | 3.056 | 2.350 |
| Hydroxy-substituted | | | 9.062 | 2.308 | 2.512 | 2.198 | 2.496 |
| phosphonic acid | | | | | | | |
| chelating agent | | | | | | | |
| (31 wt. %) | | | | | | | |
| Phosphate builder | | | 7.253 | 1.847 | 1.999 | 1.759 | 1.998 |
| Polycarboxylic acid | | | 4.534 | 1.154 | 1.205 | 1.100 | 1.201 |
| chelating agent | | | | | | | |
| Diethylene glycol hexyl | | | | 6.315 | 8.999 | 6.044 | 8.995 |
| ether | | | | | | | |
| Diethylene glycol butyl | 9.72 | 9.30 | | 2.541 | | 2.351 | |
| ether; | | | | | | | |
| Nonionic S. detersive | 1.23 | | | | | 0.297 | 0.516 |
| agent C7-2EO alcohol | | | | | | | |
| Nonionic S. detersive | | | | 6.320 | 6.498 | 6.106 | 6.503 |
| agent C7-4EO alcohol | | | | | | | |
| Nonionic S. detersive | 1.22 | | | | | 0.295 | 0.400 |
| agent ethoxylated | | | | | | | |
| secondary alcohol | | | | | | | |
| Nonionic S. detersive | | 4.27 | | | | | |
| agent ethoxylated | | | | | | | |
| Nonionic S. anti- | 0.24 | 0.97 | | | | 0.059 | 0.081 |
| foaming agent | | | | | | | |
| Nonionic S. wetting | 0.07 | 0.48 | | | | 0.016 | 0.023 |
| agent | | | | | | | |
| Anionic surfactant | 10.26 | 10.30 | | 2.682 | 2.764 | 2.481 | 2.760 |
| (70 wt. %) | | | | | | | |
| Anionic polymeric | 8.48 | 8.19 | | 2.216 | 2.264 | 2.050 | 2.253 |
| dispersant | | | | | | | |
| Aromatic Hydrotrope | | | | 33.225 | 32.980 | 36.358 | 32.990 |
| (40 wt. %) | | | | | | | |
| TOTAL | 100 | 100 | 100 | 100 | 100 | 100 | 100 |
| pH | 6.52 | 6.44 | 6.00 | 8.26 | 8.26 | 8.42 | 7.83 |

Cleaner formulations were tested for performance in removing polymeric material deposits comprising polymeric material and aluminum cations from 1 by 3 inch coupons cut from panels of anodized aluminum purchased from ACT Corp. Polymeric material deposits on test coupons was created as follows: A small volume of 1% Al(NO₃)₃ was pipetted onto a horizontal anodized aluminum coupon to form three ˜1 cm diameter liquid droplets. The coupons were then dried for 30 minutes in a 70° C. oven. The coupons—now with a thin film of solid Al(NO₃)₃ circular deposits—were then immersed for five minutes in a latex polymer-containing water-borne adhesive commercially available from Henkel Corporation. During immersion of the panel, the latex polymer destabilized and formed an adherent ring of polymeric material deposit where the Al(NO₃)₃ circular deposits had been applied. The coupons were removed from the adhesive and rinsed with water for one-minute to remove any adhered adhesive that had not been destabilized. Each rinsed coupon was immersed in a beaker containing a 10 wt. % solution of one of the cleaner concentrates forming the respective working cleaner baths. The coupons were soaked in the cleaner bath until the circular deposits came off of the coupons or a 60 minute dwell time, whichever came first. Then the coupons were removed from the cleaner solutions, rinsed with deionized water, blown dry, and assessed for cleanliness. A panel where the circular deposits had been completely removed with no film was scored as a 10 and coupons were given decreasing scores down to 1 depending on what percent of the circular polymeric ring remained on the panel.

Table 2 below compares the effectiveness of seven formulations. Note that the cleanliness is generally improving, the time for the spots to fall off is dropping, and the time before removal from the beakers is decreasing.

TABLE 2

| | | | Average Time | Total Time | Relative |
|---|---|---|---|---|---|
| | Cleaner | | Polymeric | In Cleaner | Clean- |
| | Dilution | | Spots Fell | Beaker | liness |
| Formulation | (Wt. %) | pH | Off (min.) | (min.) | (1-10) |
| Comp. Ex. 1 | 10.0 | 6.62 | 23.3 | 60 | 3 |
| Comp. Ex. 2 | 10.0 | 6.44 | 23.3 | 60 | 2 |
| Ex. 10 | 10.0 | 6.56 | 18.3 | 51 | 10 |
| Ex. 11 | 10.0 | 8.29 | 3.0 | 21 | 10 |
| Ex. 12 | 10.0 | 8.28 | 3.0 | 21 | 9 |
| Ex. 11.1 | 10.0 | 8.05 | 13.1 | 21 | 4 |
| Ex. 12.1 | 10.0 | 7.89 | 7.0 | 21 | 8 |

Assessment of the cleaners was made based on average time for polymeric spot removal and relative overall cleanliness (10 is good, 1 is poor).

### Example 2

The above test results showed that the solvent had a significant impact on the effectiveness of the cleaners. The effect of solvent on the cleaner system was investigated by making up a series of cleaner concentrates with various solvents. Solvents for testing were selected based on criteria including water solubility and flash point.

For each example in Table 3, cleaner concentrate compositions for testing were prepared by admixing the components as listed. Formulations 13A, B, C, D, E and F were substantially the same, except the solvent was varied, while G and H solvent and surfactant amounts were varied. The cleaner concentrates were assessed for phase separation or precipitate and tested for pH, results are given in Table 4, below. Despite having similar pH in the near neutral range, three of the cleaner concentrates showed precipitation.

Formulations 13A, B, C, D, E, F, G and H were diluted to working cleaner baths at 10 wt. % dilution with deionized water. Cleaner formulations were tested as follows: Test coupons from ACT anodized aluminum panels were prepared for testing according to Example 1. The coupons were immersed in a beaker of the cleaner working bath containing a 10 wt. % dilution of the cleaner concentrate. Due to the speed of cleaning provided by working cleaner bath Formulations 13A, B, C, D, E, F, G and H, the test time period was shortened from 60 minutes to 15 minutes. The coupons in the cleaner were shaken for 20-seconds, every 3 minutes. After 15 minutes, the coupons were removed from the cleaner solutions, rinsed with deionized water, blown dry, and assessed for cleanliness.

TABLE 3

| Raw material | Concentrate Cleaner Formulations | | | | | | | |
|---|---|---|---|---|---|---|---|---|
| (Wt. %) | 13.0A | 13.0B | 13.0C | 13.0D | 13.0E | 13.0F | 13.0G | 13.0H |
| DI-H₂O | 34.597 | 34.605 | 34.358 | 34.576 | 34.606 | 34.570 | 33.867 | 33.105 |
| NaOH (50 wt. %) | 2.349 | 2.348 | 2.333 | 2.369 | 2.349 | 2.344 | 2.297 | 2.245 |
| Triethanolamine | 2.350 | 2.353 | 2.333 | 2.345 | 2.348 | 2.346 | 2.299 | 2.247 |
| Phosphate builder | 1.998 | 2.000 | 1.984 | 1.997 | 2.005 | 1.996 | 1.955 | 1.911 |
| Polycarboxylic acid | 1.221 | 1.204 | 1.196 | 1.212 | 1.200 | 1.237 | 1.212 | 1.185 |
| chelating agent | | | | | | | | |
| Hydroxy-substituted | 2.506 | 2.499 | 2.498 | 2.502 | 2.500 | 2.523 | 2.472 | 2.416 |
| phosphonic acid | | | | | | | | |
| chelating agent | | | | | | | | |
| (31 wt. %) | | | | | | | | |
| Anionic polymeric | 2.250 | 2.255 | 2.232 | 2.253 | 2.251 | 2.250 | 2.204 | 2.154 |
| naphthalene dispersant | | | | | | | | |
| Aromatic Hydrotrope | 32.978 | 32.989 | 32.799 | 32.992 | 32.990 | 32.964 | 32.294 | 31.567 |
| (40 wt. %) | | | | | | | | |
| Nonionic S. detersive | 6.496 | 6.507 | 7.110 | 6.495 | 6.500 | 6.513 | 6.381 | 6.237 |
| agent C7-4EO alcohol | | | | | | | | |
| Nonionic S. detersive | 0.500 | 0.499 | 0.498 | 0.520 | 0.510 | 0.512 | 0.502 | 0.491 |
| agent C7-2EO alcohol | | | | | | | | |
| Anionic surfactant | 2.767 | 2.747 | 2.727 | 2.750 | 2.752 | 2.751 | 2.695 | 2.634 |
| (70 wt. %) | | | | | | | | |
| Nonionic S. detersive | 0.809 | 0.811 | 0.795 | 0.811 | 0.802 | 0.800 | 1.587 | 3.437 |
| agent 9EO secondary | | | | | | | | |
| alcohol | | | | | | | | |
| Nonionic antifoaming | 0.145 | 0.139 | 0.152 | 0.140 | 0.140 | 0.155 | 0.333 | 0.600 |
| Gemini surfactant | | | | | | | | |
| Nonionic S. wetting agent - | 0.042 | 0.050 | 0.043 | 0.044 | 0.043 | 0.041 | 0.113 | 0.201 |
| mixture of C8-C14 alcohols | | | | | | | | |
| having 1-24 moles of | | | | | | | | |
| ethoxylation | | | | | | | | |
| Solvent* | 8.993 | 8.994 | 8.944 | 8.995 | 9.005 | 8.997 | 8.815 | 8.616 |
| *Solvent in | DEG-BE | TPG-ME | DPG-ME | DPG-PE | DPG-BE | DEG-HE | DEG-HE | DEG-HE |
| formulation | | | | | | | | |

*DEG-BE is diethylene glycol butyl ether; DEG-HE is diethylene glycol hexyl ether; DPG-BE is dipropylene glycol butyl ether; DPG-ME is dipropylene glycol methyl ether; DPG-PE is dipropylene glycol propyl ether; TPG-ME is tripropylene glycol methyl ether.

TABLE 4

| | Concentrate Cleaner Formulations | | | | | | | |
|---|---|---|---|---|---|---|---|---|
| | 13.0A | 13.0B | 13.0C | 13.0D | 13.0E | 13.0F | 13.0G | 13.0H |
| Concentrate | No | Precip | Precip | Precip | Slight | No | No | No |
| Cleaner Stability | Precip | | | | Haze | Precip | Precip | Precip |
| Concentrate | 7.87 | 7.87 | 7.73 | 7.92 | 7.92 | 7.84 | 7.84 | 7.84 |
| Cleaner pH | | | | | | | | |

TABLE 5

| 10.0 wt. % | | | | | | | | |
|---|---|---|---|---|---|---|---|---|
| Dilution of | | | | | | | | |
| Concentrate | Testing of Working Cleaner Baths | | | | | | | |
| Cleaner | 13.0A | 13.0B | 13.0C | 13.0D | 13.0E | 13.0F | 13.0G | 13.0H |
| pH of 10.0 Wt. % | 7.92 | 7.91 | 7.82 | 7.94 | 7.94 | 7.88 | 7.88 | 7.88 |
| Working Cleaner Baths | | | | | | | | |
| Average Time Polymeric | — | 3.0 | <5 | 6.1 | 7.7 | 4.0 | 5.0 | 7.0 |
| Spots Fell Off (min.) | | | | | | | | |
| Total Time in Cleaner | 15 | 15 | 15 | 15 | 15 | 15 | 15 | 15 |
| (min.) | | | | | | | | |
| Relative Cleanliness | 4 | 6 | 8 | 2 | 6 | 10 | 4 | 7 |
| (1-10) | | | | | | | | |

The working cleaner baths were assessed based on average time to polymeric spots removal and relative cleanliness. A panel where the circular deposits had been completely removed was scored as a 10 and coupons were given decreasing scores down to 1 depending on what percent of the circular polymeric ring remained on the panel. Some cleaners showed faster spot removal, but overall cleanliness (e.g. surface haze) was poorer than some slower cleaners. Higher concentration of some surfactants, did not necessarily result in improved performance, see 13G and 13H.

The foregoing disclosure has been described in accordance with the relevant legal standards, thus the description is exemplary rather than limiting in nature. Variations and modifications to the disclosed embodiment may become apparent to those skilled in the art and do come within the scope of the disclosure. Accordingly, the scope of legal protection afforded this disclosure can only be determined by studying the following claims.

What is claimed is:

1. A cleaner composition for electronic device components that comprises, consists essentially of, or consists of:
A) water, preferably deionized water;
B) at least one source of alkalinity;
C) at least one detergent builder, different from any of the foregoing components;
D) at least one chelant, different from any of the foregoing components;
E) one or more non-ionic surfactants, desirably a combination of at least two nonionic surfactants:
E1) a detersive agent;
E2) an anti-foaming agent; and
E3) a wetting agent;
F) at least one anionic surfactant, different from any of the foregoing components;
G) at least one dispersant, different from any of the foregoing components, preferably an anionic polymeric dispersant;
H) at least one hydrotrope, preferably an aromatic hydrotrope different from any of the foregoing components;
I) at least one organic solvent, different from any of the foregoing components, preferably water soluble.

2. The cleaner composition of claim 1 wherein B) the at least one source of alkalinity comprises alkali metal hydroxide, alkanol amine or a combination thereof; and C) the at least one detergent builder comprises a water soluble detergent builder selected from phosphate builders, silicate builders and mixtures thereof.

3. The cleaner composition of claim 1 wherein D) the at least one chelant, comprises at least two chelants comprising a polycarboxylic acid chelating agent and a phosphonic acid chelating agent.

4. The cleaner composition of claim 3 wherein one or both of the polycarboxylic acid chelating agent, the phosphonic acid chelating agent are hydroxy substituted.

5. The cleaner composition of claim 1 wherein component E) the one or more non-ionic surfactants comprises:
E1) at least one detersive agent, different from any of the foregoing components, selected from alkoxylated mono alcohols, where the alkoxy groups are selected from ethoxy, propoxy, butoxy and combinations thereof,
E2) at least one antifoaming agent, different from any of the foregoing components, selected from ethers, alcohols and glycols, preferably an alcohol that is a diol; and
E3) at least one wetting agent, different from any of the foregoing components, comprising two or more C8-C14 ethoxylated alcohols.

6. The cleaner composition of claim 5 wherein the one or more non-ionic surfactants comprises at least three non-ionic surfactants, different from any of the foregoing components where:
E1) the detersive agent comprises a plurality of non-ionic surfactants, comprising an ethoxylated secondary alcohol and an aromatic ethoxylated alcohol;
E2) the anti-foaming agent comprises a C8-C18 saturated or unsaturated branched diol;
E3) the wetting agent comprises a plurality of saturated C8-C14 alcohols having 2-20 mols of ethoxylation; desirably one or more ethoxylated alcohols corresponding to the general formula:
R3-(OCH₂CH₂)ₙOH (E3)
where R3 is a C6 to C18 alkyl; desirably C8 to C14 alkyl; and
n is in a range of 1 to 30, desirably 2 to 24, preferably 1 to 12.

7. The cleaner composition of claim 1 wherein F) the at least one anionic surfactant is selected from alkyl sulfates, alkyl sulfonates, alkyl phosphates, alkyl phosphonates, alkylsulfosuccinates, and their ethoxylated analogs.

8. The cleaner composition of claim 1 wherein G) the at least one dispersant comprises an anionic organic polymeric dispersant with MW in a range of about 5,000 to about 10,000 grams/mol, and comprising one or more polar or dissociable functional groups selected from hydroxyl (—OH), carboxyl (—COOH), sulfonate, sulfate, amino (—NH₂), imino (—NH—), and polyoxyethylene (—CH2 CH2O—) groups.

9. The cleaner composition of claim 8 wherein the anionic organic polymeric dispersants is selected from condensed naphthalene sulphonic acid; condensed 1-naphthol 6-sulphonic acids; a fatty alcohol ethylene oxide condensate; an alkyl aryl sulphonate; and lignin sulphonate; sulfonic acids polyacrylic acid (PAA), polymethacrylic acid (PMAA); and salts thereof.

10. The cleaner composition of claim 1 wherein H) the at least one hydrotrope, comprises one or more of butyl benzene sulfonate, sodium benzoate, sodium benzene sulfonate, sodium benzene di-sulfonate, sodium m-nitrobenzene sulfonate, sodium butyl monoglycol sulfate, sodium cinnamate, sodium cumene sulfonate, sodium p-toluene sulfonate, sodium salicylate, sodium xylene sulfonate and combinations thereof.

11. The cleaner composition of claim 1 wherein I) the at least one organic solvent comprises a glycol ether, a glycol ether ester or a combination thereof.

12. The cleaner composition of claim 11 wherein I) the at least one organic solvent comprises one or more of ethylene glycol phenyl ether, propylene glycol phenyl ether, dipropylene glycol n-propyl ether; diethylene glycol monobutyl ether acetate; diethylene glycol monohexyl ether; bis-dipropylene glycol n-butyl ether adipate; and combinations thereof.

13. A method of cleaning electronic device components, comprising steps of:
1) contacting a surface of an article of manufacture, a component, or an assembly thereof, (a part) with the cleaner composition of any one of the foregoing claims;
2) optionally inducing movement of the cleaner composition relative to the surface of the part;
3) maintaining contact between the cleaner composition and the part surfaces for a time sufficient to remove polymeric material residue from surfaces of the part, in particular holes and bores in said part;
4) removing the part from the cleaner composition;
5) rinsing any residual cleaner composition and polymeric material residue from the part surface and
6) optionally drying the part.

14. The method of cleaning electronic device components of claim 13 wherein the electronic device components have a low mass in a range of about 2 grams to 50 grams and/or intricate geometries; and the contacting step is at a temperature of less than 90° C., desirably in a range of about 15° C. to about 75° C. and most preferably about 20° C. to about 40° C.

15. The method of cleaning electronic device components of claim 13 wherein the contacting step is for a time ranging from about 0.5-15 minutes, preferably about 1-10 minutes, most preferably about 2-7 minutes.

16. The method of cleaning electronic device components of claim 13 wherein the electronic device components comprise bare, ceramicized or anodized metal surfaces, and the metal surfaces being comprised of at least one of aluminum, titanium, magnesium, or stainless steel.
